(19) United States
(12) Patent Application Publication
(10) Pub. No.: US 2008/0129634 A1
(43) Pub. Date: Jun. 5, 2008

(54) MULTI-POLARIZATION ANTENNA FEEDS FOR MIMO APPLICATIONS

(76) Inventors: Robert J. Pera, San Jose, CA (US); Thomas Birnbaum, Santa Cruz, CA (US)

Correspondence Address: HAHN AND MOODLEY, LLP, P.O. BOX 52050, MINNEAPOLIS, MN, 55402, US

(21) Appl. No.: 11/685,998

(22) Filed: Mar. 14, 2007

Related U.S. Application Data
(63) Continuation-in-part of application No. 11/565,511, filed on Nov. 30, 2006.

(51) Int. Cl. H01Q 21/24

(52) U.S. Cl. 343/853

(57) ABSTRACT

Methods and systems for exploiting orthogonal antenna polarizations which restore MIMO capability to an otherwise single path link are disclosed. Disclosed multi-polarization antennae and antennae arrays create two orthogonally polarized independent channels of communication which are transmitted and received by similar multi-polarization antennae, taking advantage of the fact that orthogonally polarized electromagnetic waves travel independently and can be used as independent communication channels. Transmitters; and receivers comprising such multi-polarization antennae behave as if two independent communication channels are available in the same line-of-sight link, allowing a doubling of the bandwidth and providing a way to exploit MIMO in outdoor and other line-of-sight communication links.

This application is a continuation-in-part of U.S. patent application Ser. No. 11/565,511 filed on 30 Nov. 2006.

### FIELD

Embodiments of the invention relate generally to MIMO communications.

### BACKGROUND

Wireless communication networks, such as those based on an IEEE (institute of Electrical and Electronics Engineers) 802.11 protocol (also known as Wi-Fi), can achieve greater data throughput using a technique known as multiple-input-multiple-output (MIMO). MIMO relies on multiple antennae to exploit multiple electromagnetic transmission paths available to radio signals traveling in a highly reflective indoor propagation environment. However, when deploying MIMO transmitters and receivers in an outdoor environment or any large open area where there is line-of-sight between the transmitter and the receiver, the communication reduces to essentially a point-to-point communication and the underlying multiple transmission paths required by a MIMO communications system are no longer present.

### SUMMARY

Methods and systems for exploiting orthogonal antenna polarizations which restore MIMO capability to an otherwise single path link are provided. In one embodiment, multi-polarization antennae and antennae arrays create multiple orthogonally polarized independent channels of communication which are transmitted and received by similar multi-polarization antennae, thereby taking advantage of the fact that orthogonally polarized electromagnetic waves travel independently and can be used as independent communication channels. Transmitters and receivers comprising the multi-polarization antennae behave as if independent communication channels are available in the same line-of-sight link, allowing an increase in bandwidth and providing a way to exploit MIMO in outdoor and other line-of-sight communication links.

### BRIEF DESCRIPTION OF DRAWINGS

FIG. 1 illustrates a transceiver system using multi-polarization antenna feeds, in accordance with an embodiment of the present invention.

FIG. 2 illustrates a multi-polarization microstrip patch antenna, in accordance with an embodiment of the present invention.

FIG. 3 illustrates a plurality of multi-polarization patch antenna elements 202 arranged in an array, in accordance with an embodiment of the present invention.

FIG. 4 illustrates a feed arrangement for a patch antenna array.

FIG. 5 illustrates a feed element for a dish aperture antenna.

### DETAILED DESCRIPTION

In the following description, for purposes of explanation, numerous specific details are set forth in order to provide a thorough understanding of the invention. It will he apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Multiple-input-multiple-output (MIMO) communication is used in wireless communication networks, such as those based on an IEEE 802.11n protocol. MIMO wireless communications use multiple antennae to exploit the multiple paths available to radio signals traveling in a highly reflective indoor propagation environment. Outdoors, or in large open indoor spaces, there are far fewer reflections and thus less multipath propagation. Therefore MIMO systems rapidly lose their advantage over conventional wireless links in an outdoor environment. When deploying MIMO transmitters and receivers in an outdoor environment or any large open area where there is line-of-sight between the transmitter and the receiver, the communication reduces to essentially a point-to-point communication and the underlying multi-path assumptions of MIMO are no longer valid. In such a scenario, not only does MIMO fail to boost existing line-of-sight bandwidths, but the extra overhead of attempting to exploit MIMO outdoors actually costs throughput or power and MIMO becomes a burden.

The present embodiments disclose techniques which exploit orthogonal polarizations which, especially in outdoor point-to-point links, restore MIMO capability to an otherwise line-of-sight link. As disclosed herein, multi-polarization antennae and antennae arrays create at least two orthogonally polarized independent channels of communication which are transmitted and received by a similar multi-polarization antenna, taking advantage of the fact that orthogonally polarized electromagnetic waves travel independently and can be used as independent communication channels A MIMO transmitter or receiver comprising such multi-polarization antennae behaves as if it has at least two independent communication channels available to it in the same line-of-sight link. This allows an increase in bandwidth and provides a way to exploit MIMO in outdoor and other line-of-sight communication links. However, it is understood that the advantages of the present embodiments do not require a line-of-sight link.

While a particularly popular application of MIMO is for communications in accordance with the IEEE 802.11n and similar wireless protocols, it is to be understood that the multi-polarization MIMO techniques disclosed by the present embodiments can in general be applied to communications in accordance with other protocols. Thus, the techniques disclosed herein are not dependent upon any particular frequency range or any particular communication protocol or standard.

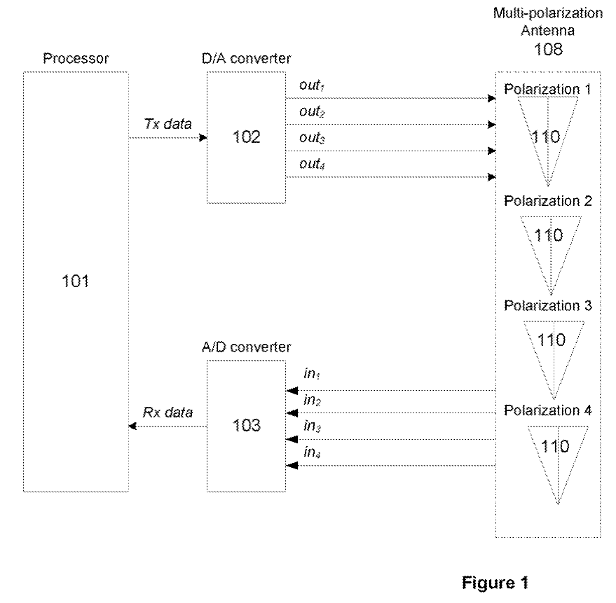

FIG. 1 illustrates a transceiver system using multi-polarization antenna feeds, in accordance with an embodiment of the present invention. The system comprises a processor 101, a digital-to-analog converter 102, an analog-to-digital converter 103, frequency converters 104, power amplifiers 105, low noise amplifiers 106, transceivers 107, and a multi-polarization antenna 108 having a plurality of antenna elements 110. In one embodiment, the multi-polarization antenna 108 may include four antenna elements 110. Each of the antenna elements 110 is capable of transmitting and receiving energy in a mutually orthogonal polarization sense or direction. For example, a first of the antenna elements 110 may be capable of sending and receiving energy polarized in a horizontal direction, a second of the antenna elements 110 may be capable of sending and receiving energy polarized in a vertical direction, a third of the antenna elements 110 may be capable of sending and receiving energy polarized in a right-circular direction, and a fourth of the antenna elements 110 may be capable of sending and receiving energy polarized in a left-circular direction. In an implementation of the transceiver system, one or more of these components may reside on an integrated circuit chip. For example, in one embodiment, the processor 101, the digital-to-analog converter 102, the analog-to-digital converter 103, and the frequency converters 104 are implemented on the same integrated circuit chip.

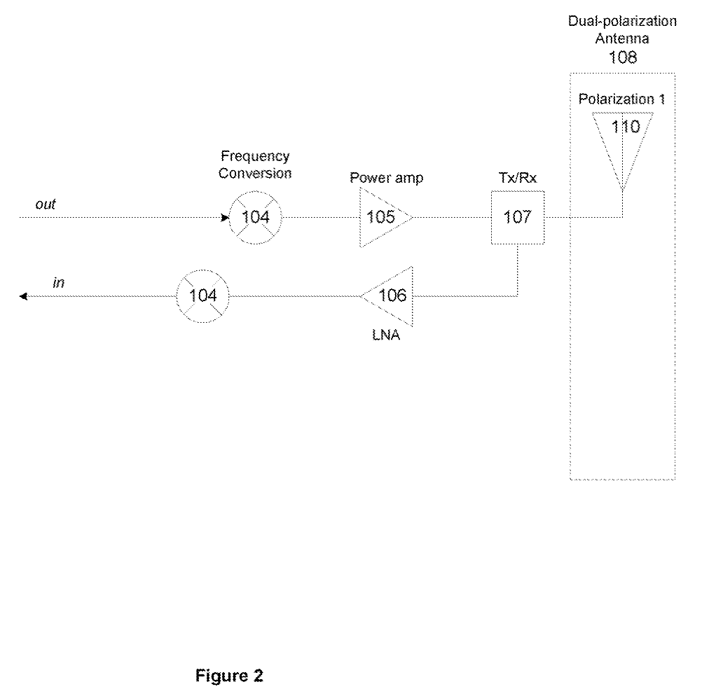

Processor 101 has access to a plurality of independent channels, one per antenna element 110 of the multi-polarization antenna 108. The number of independent channels may range between two to four depending on the number of antenna, elements 110 that comprise the multi-polarization antenna 108. In the embodiment shown in FIG. 1 of the drawings, there are four independent channels, each capable of sending and receiving energy according to four mutually orthogonal polarization senses. To send signals over each of the independent channels, processor 101 sends the signals to the digital-to-analog converter 102. The signals are converted into four corresponding analog signals, designated out₁, out₂, out₃, and out₄ FIG. 1. Each of the analog out signals is frequency converted by a converter 104, amplified by a power amplifier 105, and sent by a transceiver 107 to the multi-polarization antenna 108 for transmission as can be seen in FIG. 2 of the drawings. The first signal out₁ is transmitted according to a first polarization, the second signal out₂ is transmitted according to a second polarization, the third signal out₃ is transmitted according to a third polarization the third signal out_{3,} and the fourth signal out₄ is transmitted according to a fourth polarization. The polarizations are substantially orthogonal, thereby providing four substantially independent electromagnetic transmissions which can simultaneously and independently carry the four analog signals. The processor 101 may use each of the channels simultaneously or at different times.

In the embodiment of FIG. 1, four orthogonally polarized electromagnetic transmissions are received by the multi-polarization antenna 108. The first, transmission carries a first signal and is polarized according to the first polarization, the second transmission carries a second signal and is polarized according to the second polarization, the third transmission carries a third signal and is polarized according to the third polarization, and the fourth transmission carries a fourth signal and is polarized according to the fourth polarization. The four analog signals (labeled in₁, in₂, in₃ and in₄) carried by the four transmissions are sent by transceivers 107 to the low noise amplifiers 106, converted by the frequency converters 104 and further converted to digital signals by the analog-to-digital converter 103, as is shown if FIG. 2 of the drawings. The resulting digital signals represent the received data which are then handled by the processor 101 for downstream processing.

The signals may carry data that is packetized (for example according to an IEEE 80211 or other packet-based communication protocol) or data that is not packetized. In the case of packetized data transmission, the processor 101 prepares the data for transmission as data packets. In the case of packetized data reception, the processor 101 receives the data as packets.

The disclosed techniques can be applied to any type of antenna that can accept at least two orthogonal inputs to produce at least two orthogonally polarized electromagnetic fields, such as microstrip patch antennae and aperture dish antennae which allow feeds with multiple polarities and can send or receive multiple signals according to the multiple polarities. Aperture dish antennae may achieve higher gains than patch antennae for point-to-point communication. By way of example and not limitation, the present techniques are hereinafter disclosed with reference to microstrip patch antennae. Generally, a microstrip patch antenna is etched on a two-layer printed circuit board with a ground plane layer and an antenna element layer. The antenna element is about ½ wavelength in length (representing the resonant length) and typically ¼ to 2 wavelengths wide. It is excited by a feed located at or near one edge. If made square, the antenna will resonate along both the vertical and horizontal axes.

FIG. 2 illustrates a multi-polarization microstrip patch antenna, in accordance with an embodiment of the present invention. The microstrip patch antenna is etched on a two-layer printed circuit board with a ground plane layer 201 and an antenna element layer 202. The antenna is made to be substantially square so that it may resonate along both the vertical and horizontal axes. The square patch antenna is fed in at least two places orthogonally in order to produce at least two independent radiated signals. In one embodiment, the antenna may be excited by a feed 203 located at or near a vertical edge, as well as a feed 204 located at or near a horizontal edge so that two polarizations are generated along the axes of the feeds 203 and 204.

The two feeds interact minimally and for practical purposes can be assumed to be independent channels. When a patch element is excited in one polarization, the fields and the currents on that element are independent and do not interact with the fields and currents flowing in the orthogonal direction. Furthermore, while a portion of the energy going into one polarization feed may leak out of the other polarization feed, it is generally small and as a practical matter can be ignored.

Note that a multi-polarization transmitter and receiver can maintain a high communication bandwidth between them as long as their polarizations substantially match, i.e. as long as their relative spatial orientations are such that the vertical and horizontal axes of their antennae are substantially aligned. One way of providing for this relative orientation is to have the receiver and transmitter antennae stationary and in a fixed and aligned orientation relative to each other.

Patch antenna elements can be arranged in many configurations to create antenna arrays for producing higher gain than a single element. Such an array can be used in place of the multi-polarization antenna 108 in the system shown in FIG. 1. As disclosed herein, such antenna arrays can also be fed orthogonally to produce independent channels.

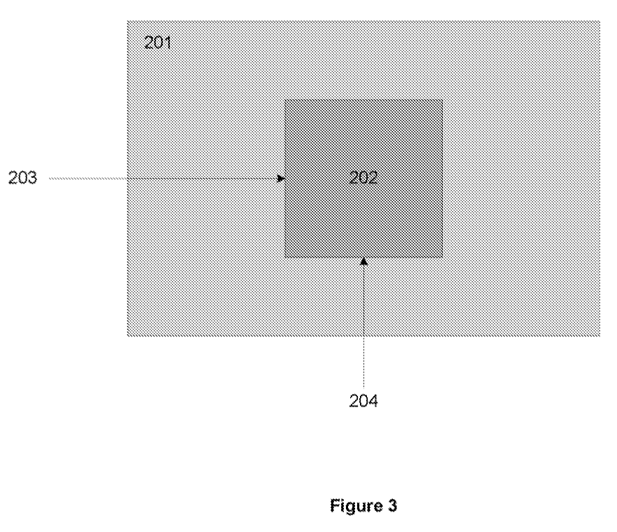

FIG. 3 illustrates a feed arrangement for a plurality of multi-polarization patch antenna elements 202 arranged in an array, in accordance with an embodiment of the present invention. While the antenna array shown is a 9-element square patch antenna array, the number of elements may vary and can be any other m×n dimensions or other irregular arrangement. The particular antenna array shown in FIG. 3 produces about 8 dB more gain than a single patch antenna element.

In one embodiment, a combination of corporate and series feeding provides an efficient and elegant interconnection scheme providing the antenna elements 202 with feeds of two polarizations. The array is fed by two central energy feed lines 205 and 207, one per polarization. The rows are corporate fed by the central row feed 205 which branches out and is connected to one element 202 per row. Along the rows, the elements 202 are connected in series by row interconnects 206 and are series fed downstream from the corresponding branches of the central row feed 205. The columns are corporate fed analogously by the central column feed 207, with the elements 202 connected in series along the columns by column interconnects 208 and series fed downstream from the corresponding branches of the central column feed 207. As in the case of the single element 202, the two feeds 205 and 207 are independent and represent two independent channels. One advantage of the combination of corporate and series feeding is that complex routing from the feed lines 205 and 206 to individual antenna elements 202 is avoided.

A further advantage of the combining series and corporate feeds, as disclosed herein, is that it helps distribute the energy provided by the central feeds 205 and 207 more evenly across the antenna elements 202. Such even distribution is especially important in high gain antenna applications having an array comprising many antenna elements 202. In one embodiment comprising an n×n array, the central feeds 205 and 207 branch out such that they each split the power evenly across their n branches. The impedance of the antenna elements 202 is designed such that the first antenna element in a series fed sequence of w antenna elements 202 in a row (respectively column) removes only one n-th of the energy from its central row feed 205 branch (respectively column feed 207 branch) and radiates it, allowing the rest of the energy to travel past that antenna element to the remaining elements 202 in the row (respectively column).

The next antenna element in the row (respectively column) removes another one n-th of the supplied energy and radiates it, and so on, until the last element receives the last n-th and radiates it. This way, both feed lines 205 and 207 (for both polarizations) distribute their energy evenly across the elements 202 of the antenna array. The proper impedance of the patch elements 202 for a row (or column) can be determined by using a series of equations which take into account the impedance of the series connected antenna elements in the row (or column), as well as the impedance of their interconnects 206 (or 208), and by iterating until an acceptable approximation is reached, as should be obvious to one of ordinary skill in the art.

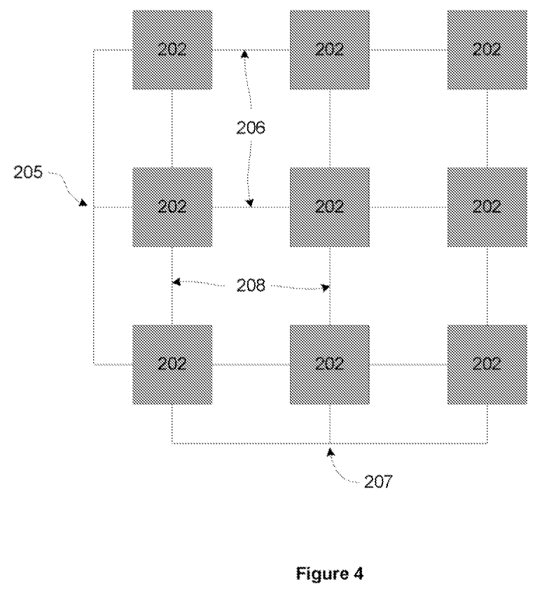

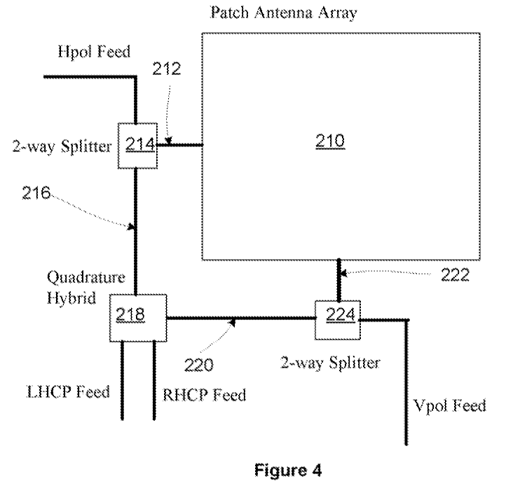

The multi-polarization feed technique is not limited to linear polarization, such as the above described vertical and horizontal polarization, but can also be applied using circular polarization. FIG. 4 illustrates a feed arrangement for a patch antenna array 210 comprising a plurality of patch antenna elements 202, in accordance with another embodiment of the invention. Referring to FIG. 4, a horizontally polarized feed Hpol is fed into a two-way splitter 214 which sends the Hpol feed along line 212 into the array 210. The array 210 is thus excited to cause it to radiate horizontally polarized energy. Likewise, a vertically polarized field Vpol is fed into a two-way slitter 224 which sends the Vpol feed along line 222 into the array 210. The array 210 is thus excited to radiate vertically polarized energy. To cause the array 210 to radiate Left Hand Circularly Polarized (LHCP), a LHCP feed is fed into a quadrature hybrid 218 which splits the LHCP feed into two 90° phase-shifted signals that travel along the lines 216 and 220, respectively, through the splitters 214 and 224, respectively, and into the array 210. Likewise to cause the array 210 to radiate Right Hand Circularly Polarized (RHCP) energy a RHCP feed is fed into the quadrature hybrid 218 which splits the RHCP feed into two 90° phase-shifted signals that travel along the lines 216 and 220, respectively, through the splitters 214 and 224, respectively, and into the array 210. Thus, the array 210 has four transmit-inputs, viz. Hpol, Vpol, LHCP, and RHCP. The array 210 is also able to receive four outputs, viz. Hpol, Vpol, LHCP, and RHCP.

In an alternative embodiment, the individual patch elements are altered to generate circular polarization, with a first polarization being a left hand polarization and a second orthogonal polarization being a right hand polarization. A patch antenna element can be made to generate circular polarization by adjusting its dimension very slightly, for example by feeding it from opposite corners. Since such circular polarizations are also independent, circularly polarized antennae and antenna arrays can be used in place of linearly polarized antennae to produce two independent channels and double the bandwidth.

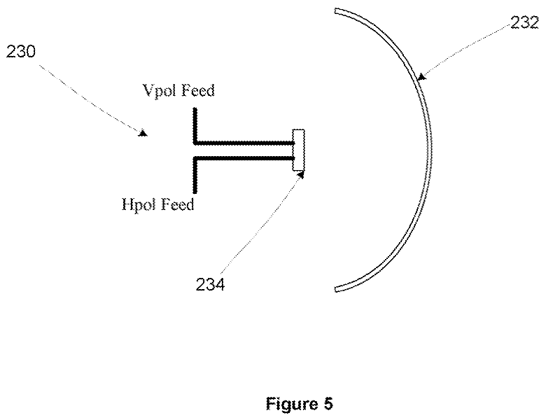

It is to be understood that embodiments of the invention may be practiced using antennas other than patch antennas. For example, as is shown in FIG. 5 of the drawings, a dish aperture antenna may be used in some embodiments. Referring to FIG. 5, an antenna feed element 230 is used to energize a dish aperture 232. The antenna feed element 230 comprises a transmission element 234 to transmit or radiate energy supplied by feed designated Vpol and Hpol, respectively. When energized by the Vpol feed the element 234 radiates horizontally polarized energy, whereas when energized by the Hpol feed, the element radiates vertically polarized energy. The feed can also use a quadrature hybrid like the patch array and LHCP and RHCP can be generated by the feed and reflected by the dish aperture. In this case (and referring to FIG. 4), 210 becomes the reflector and 212 and 222 are not physical connections but are radiated from the feed. The element 234 may comprise orthogonal dipole, slots, or patch element, in accordance with different embodiments,

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A system, comprising:
a processor to prepare data for transmission as data packets; and
a transceiver to send the data packets over at least two communication channels, each communication channel defined by a signal having a polarization, wherein the at least two channels are in line-of-sight contact with a receiver for receiving the signals, and the polarization of each signal is different.

2. The system of claim 1, wherein the transceiver transmits four signals simultaneously.

3. The system of claim 2, wherein the polarization for each signal is selected from the group consisting of a vertical polarization, a horizontal polarization, a Left Hand Circular Polarization(LHCP); and a Left Hand Circular Polarization(RHCP).

4. The system of claim 3, wherein the transceiver comprises one or more patch antenna elements arranged in an array comprising m rows and n columns.

5. The system of claim 4, wherein the antenna elements are interconnected using a combination of series feeding and corporate feeding.

6. The system of claim 5, further comprising:
a first feed line for supplying first energy to the antenna elements to cause the antenna elements to radiate energy according to a horizontal polarization, the first feed line branching out into m branches in a corporate feed to one antenna element per row, the antenna elements connected in series along the rows and series fed downstream from the branches of the first feed line; and
a second feed line for supplying second energy to the antenna elements to cause the antenna elements to radiate energy according to a vertical polarization, the second feed line branching out into n branches in a corporate feed to one antenna element per column, the antenna elements connected in series along the columns and series fed downstream from the branches of the second feed line.

7. The system of claim 6, wherein the first feed line supplies third energy to the antenna elements to cause the antenna elements to radiate energy according to a LHCP; and the second feed line supplies fourth energy to the antenna elements to cause the antenna elements to radiate energy according to a RHCP.

8. The system of claim 7, further comprising a quadrature hybrid to phase shift the third energy 90° from the first energy.

9. The system of claim 8, wherein the quadrature hybrid phase shifts the fourth energy 90° from the second energy.

10. The system of claim 7, wherein the impedances of the antenna elements are chosen such that the energy supplied by the first and second feed lines is evenly distributed across the antenna elements.

11. The system of claim 5, wherein the antenna elements comprise aperture dish antennae or microstrip patch antennae.

12. A method, comprising:
preparing data for transmission as data packets; and
sending the data packets over at least two communication channels, each communication channel defined by a signal having a polarization; wherein the at least two channels are in line-of-sight contact with a receiver for receiving the signals, and the polarization of each signal is different.

13. The method of claim 12, wherein the transceiver transmits four signals simultaneously.

12. The method of claim 13, wherein the polarization for each signal is selected from the group consisting of a vertical polarization, a horizontal polarization, a Left Hand Circular Polarization(LHCP); and a Left Hand Circular Polarization(RHCP).

15. The method of claim 12, wherein the signals are transmitted using antenna elements arranged in an array comprising m rows and n columns.

16. The method of claim 15, wherein the antenna elements are interconnected using a combination of series feeding and corporate feeding.

17. The method of claim 12, further comprising:
supplying first energy to the antenna elements to cause the antenna elements to radiate energy according to a horizontal polarization along a first feed line, the first feed line branching out into m branches in a corporate feed to one antenna element per row, the antenna elements connected in series along the rows and series fed downstream from the branches of the first feed line; and
supplying second energy to the antenna elements to cause the antenna elements to radiate energy according to a vertical polarization along a second feed line, the second feed line branching out into n branches in a corporate feed to one antenna element per column, the antenna elements connected in series along the columns and series fed downstream from the branches of the second feed line.

18. The method of claim 17, wherein the first feed line supplies third energy to the antenna elements to cause the antenna elements to radiate energy according to a LHCP; and the second feed line supplies fourth energy to the antenna elements to cause the antenna elements to radiate energy according to a RHCP.

19. The method of claim 12, further comprising:
receiving signals carrying energy, each according to a different polarization.

20. The method of claim 1.9, wherein the signals are received simultaneously.
